(19) United States
(12) Patent Application Publication
(10) Pub. No.: US 2016/0006823 A1
(43) Pub. Date: Jan. 7, 2016

(54) LOCATION SPECIFIC EXPERIENCE APPLICATION

(71) Applicant: SmugMug, Inc., Mountain View, CA (US)

(72) Inventors: Brian STRONG, San Jose, CA (US); Don MACASKILL, Los Altos, CA (US)

(21) Appl. No.: 14/788,043

(22) Filed: Jun. 30, 2015

Related U.S. Application Data
(60) Provisional application No. 62/020,733, filed on Jul. 3, 2014.

(51) Int. Cl. H04L 29/08; H04L 12/18

(52) U.S. Cl. CPC H04L 67/18; H04L 12/1859; H04L 12/1845

(57) ABSTRACT

Embodiments described herein generally relate to a social media platform which provides a location specific experience. An application, such as a website or mobile app, may provide a community of users the opportunity to connect with various media based upon the user's physical location. Application users may create and access media with others users within the application. Various media may be created and associated with a physical location utilizing a location based service. The application may allow users to access location specific media based on the user's vicinity of the media to provide the user with a unique location based experience.

### CROSS-REFERENCE TO RELATED APPLICATIONS

This application claims benefit of U.S. Provisional Patent Application No. 62/020,733, filed Jul. 3, 2014, the entirety of which is herein incorporated by reference.

### BACKGROUND

1. Field

Embodiments described herein generally relate to a social media platform. More specifically, embodiments provided herein relate to a location specific experience application.

2. Description of the Related Art

Social media has gained prevalence in today's society enjoyed by few other technologies. Millions of people participate in social media, and social media has influenced how many individuals access and consume almost all types of media. People share personal information, news, photos, videos and many other types of media via social media. A user of social media can access all of this information by simply having an internet connection.

Location based services, which utilize information regarding the geographical position of a mobile device, are often integrated into social media and social networking platforms. A user's geographical location may be incorporated into the social media network if the user so desires. For example, a user may choose to share their geographical location with others on the social media platform. However, the integration of location based services and social media are in their relative infancy. Often, a user of social media which incorporates location based services simply shares the user's physical location with others on the social media platform. Thus, the opportunity for a more in depth media experience when the user is at a specific geographical location is limited to sharing the geographical location of the user.

Therefore, what is needed in the art is a social media application which integrates location based services and provides users of the application with a more unique experience with respect to a specific geographical location. More specifically, what is needed in the art is location specific experience application.

### SUMMARY

Embodiments described herein generally relate to a social media platform which provides a location specific experience. An application, such as a website or mobile app, may provide a community of users the opportunity to connect with various media based upon the user's physical location. Application users may create and access media with others users within the application. Various media may be created and associated with a physical location utilizing a location based service. The application may allow users to access location specific media based on the user's vicinity of the media to provide the user with a unique location based experience.

In one embodiment, a method of generating and determining access to media content is provided. The method comprises creating a media item associated with a geographical location and determining an access proximity to the media item. The media item and the access proximity may be displayed on a graphical user interface and the geographical location of a user relative to the access proximity may be determined. A determination may then be made whether to allow or deny the user access to the media item by comparing the user's geographical location to the access proximity associated with the media item.

In another embodiment, a non-transitory computer-readable storage medium, storing instructions that when executed by a processor, cause the processor to generate and determine access to media content, by performing the steps of creating a media item associated with a geographical location and determining an access proximity to the media item. The media item and the access proximity may be displayed on a graphical user interface and the geographical location of a user relative to the access proximity may be determined. A determination may then be made whether to allow or deny the user access to the media item by comparing the user's geographical location to the access proximity associated with the media item.

In yet another embodiment, a computer system for generating and determining access to media content is provided. The system comprises a processor and a memory storing instructions that, when executed by the processor, cause the computer system to create a media item associated with a geographical location and determining an access proximity to the media item. The media item and the access proximity may be displayed on a graphical user interface and the geographical location of a user relative to the access proximity may be determined. A determination may then be made whether to allow or deny the user access to the media item by comparing the user's geographical location to the access proximity associated with the media item.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a computer system configured for providing a website having a location specific experience application according to one embodiment described herein.

FIG. 2 illustrates a more detailed view of a server of FIG. 1 according to one embodiment described herein.

FIG. 3 illustrates a user computing system used to access a website and utilize the location specific experience application according to one embodiment described herein.

FIG. 4 illustrates the location specific experience application displayed on a GUI of a mobile device and an enlargement of the GUI according to one embodiment described herein.

FIG. 5 illustrates an experience of the location specific experience application displayed on the GUI of FIG. 4 and an enlargement of the GUI according to one embodiment described herein.

FIG. 6 schematically illustrates operations of a method to generate a media item according to one embodiment described herein.

FIG. 7 schematically illustrates operations of a method for determining access to a media item provided by the location specific experience application according to one embodiment described herein.

To facilitate understanding, identical reference numerals have been used, where possible, to designate identical elements that are common to the Figures. It is contemplated that elements disclosed in one embodiment may be beneficially utilized in other embodiments without specific recitation.

### DETAILED DESCRIPTION

Embodiments described herein generally relate to a location specific experience application. The location specific experience application provides a social media network with integrated location based services to generate location specific content which may be created and accessed by users of the application. By automatically determining a user's geographical location, the application may provide for a media experience uniquely tailored to the location of the user. Media created in the application may be associated with a geographical location and users of the application within a certain distance or radius of the media may access the media based upon the user's geographical location. Thus, media may be created and accessed when a user is physically present near the geographical location associated with the media.

The term “user” as used herein includes, for example, a person or entity that owns a computing device or a wireless device; a person or entity that operates or utilizes a computing device or a wireless device; or a person or entity that is otherwise associated with a computing device or a wireless device. It is contemplated that the term “user” is not intended to be limiting and may include various examples beyond those described.

The term “media” or “media item” as used herein includes, for example, messages, photos, videos, audio, blogs, advertisements, geotags, notifications, and various other types of media which may be consumed by a user. The term “experience” as used herein may include media or media items associated with a geographical location. It is contemplated that the terms “media,” “media item,” or “experience” are not intended to be limiting and may include various examples beyond those described.

The term “location based services” as used herein includes, for example, global positioning systems, computer program services adapted to provide location data, information services integrated with geographical location and/or position information, tracking services, real time locating systems, positioning services utilizing control plane locating and/or GSM localization, self-reported positioning (i.e. checking-in), location based networks, local-range technologies (i.e. BLUETOOTH®, WLAN, infrared, and/or RFID technologies), and other types of geographical position/location systems. It is contemplated that the term “location based services” is not intended to be limiting and may include various examples beyond those described.

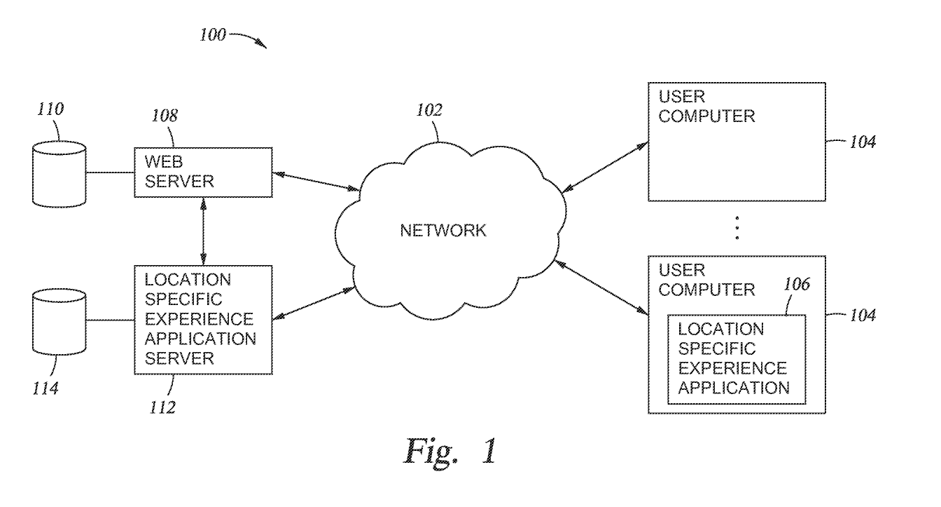

FIG. 1 illustrates a computer system configured for providing a location specific experience application. As shown, the computing system 100 may include a web server 108, a location specific experience application server 112, and a plurality of user computers (i.e. mobile/wireless devices) 104 (only two of which are shown for clarity), each connected to a communications network 102 (e.g., the Internet/social media platform). For example, the web server 108 may be programmed to communicate with the user computers 104 and the location specific experience application server 112 using a networking protocol such as TCP/IP protocol. The location specific experience application server 112 may communicate directly with the user computers 104 through the communications network 102.

Each user computer 104 may include conventional components of a computing device, e.g., a processor, system memory, a hard disk drive, a battery, input devices such as a mouse and a keyboard, and/or output devices such as a monitor or graphical user interface (GUI), and/or a combination input/output device such as a touchscreen which not only receives input but also displays an output. The web server 108 and the location specific experience application server 112 may include a processor and a system memory (not shown), and may be configured to manage media content stored in its respective content storage unit 110 and 114 using a file system and/or relational database software. The location specific experience application server 112 may be a web server configured to manage media content associated with a geographical location stored in its respective content storage unit 114. The location specific experience application server 112 may be configured to receive input from a user, such as creating media associated with a geographical location or accessing media associated with a geographical location.

In the embodiments described below, users are respectively operating the user computers 104 that may communicate over the network 102 to request media from the location specific experience application server 112. Each user computer 104 may be configured to execute a software application, such as a location specific experience application 106, and access media managed by the location specific experience application server 112. The media displayed to a user may be transmitted from the location specific experience application server 112 to the user's computer 104 and processed by the location specific experience application 106 for display through a GUI of the user's computer 104.

In one example, media displayed on the user's computer 104 may be a media item associated with a geographical location created by the user when the user was at the geographical location associated with the media item. The user's computer 104 may access the location specific experience application server 112 which, in turn, retrieves the user's media item from storage 114, and causes the user's media item to be displayed through the location specific experience application 106 on the user's computer 104 when the user is within a specified vicinity of the geographical location associated with the media item. The user's media item may be managed by the user with a username and password combination, or other similar restricted access/verification required access methods, which allow the user to “log in” and make changes to the media item. Changes or alterations made by the user to their media item on the user computer 104 may be transmitted through the communications network 102 to the location specific experience application server 112. The location specific experience application server 112 may transfer the user's media item to storage 114 where it may be retrieved and viewed by any other users accessing the location specific experience application 106.

In another example, media displayed on a first user's computer 104 may be a media item associated with a geographical location created by a second user of the location specific experience application 106. The first user's computer 104 may access the location specific experience application server 112, which, in turn, retrieves the second user's media from storage 114, and causes the second user's media item to be displayed through the location specific experience application 106 on the first user's computer 104 when the first user is within a specified vicinity of the geographical location associated with the media item of the second user.

It is noted that the user computer 104 may be a personal computer, laptop, mobile computing device, smart phone, video game console, home digital media player, network-connected television, set top box, and/or other computing devices having components suitable for communicating with the communications network 102. The user computer 104 may also execute other software applications configured to receive media content and location specific experience information from the location specific experience application server 112, such as, but not limited to, location based services, media display software, media players, computer and video games, and/or widget platforms, among others.

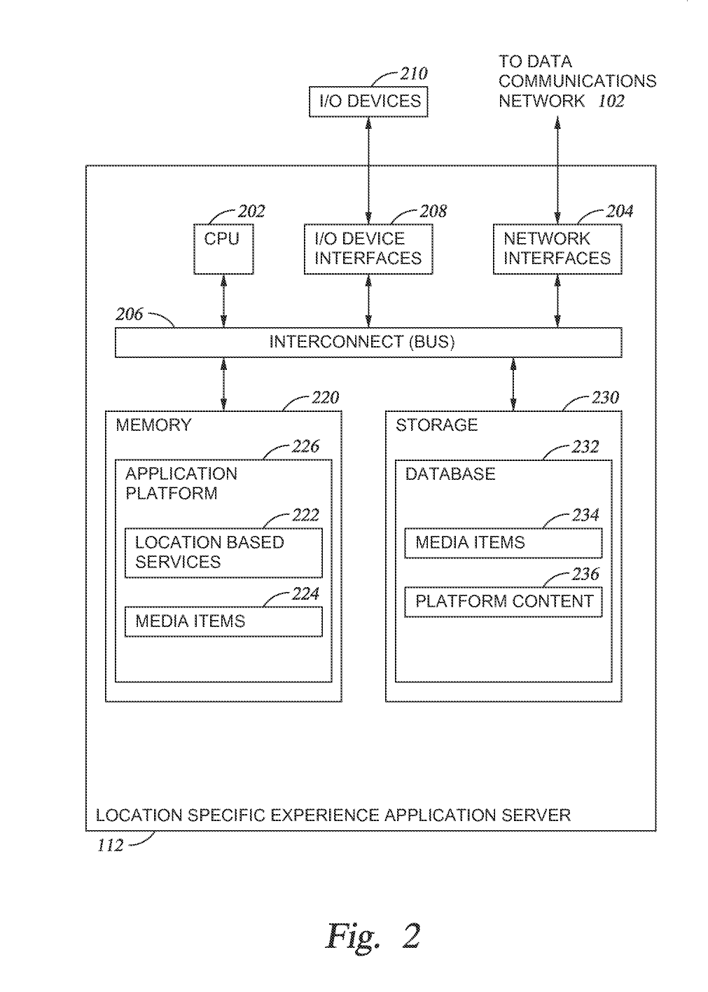

FIG. 2 illustrates a more detailed view of the location specific experience application server 112 of FIG. 1. The location specific experience application server 112 includes, without limitation, a central processing unit (CPU) 202, a network interface 204, memory 220, and storage 230 communicating via an interconnect bus 206. The location specific experience application server 112 may also include I/O device interfaces 208 connecting I/O devices 210 (e.g., keyboard, video, mouse, audio, touchscreen, etc). The location specific experience application server 112 may further include a network interface 204 configured to transmit data via the communications network 102.

The CPU 202 retrieves and executes programming instruction stored in the memory 220 and generally controls and coordinates operations of other system components. Similarly, the CPU 202 stores and retrieves application data residing in the memory 220. The CPU 202 is included to be representative of a single CPU, multiple CPU's, a single CPU having multiple processing cores, and the like. The interconnect 206 is used to transmit programming instructions and application data between the CPU 202, I/O device interfaces 208, storage 230, network interface 204, and memory 220.

The memory 220 is generally included to be representative of a random access memory and, in operation, stores software applications and data for use by the CPU 202. Although shown as a single unit, the storage 230 may be a combination of fixed and/or removable storage devices, such as fixed disk drives, floppy disk drives, hard disk drives, flash memory storage drives, tape drives, removable memory cards, CD-ROM, DVD-ROM, Blu-Ray, HD-DVD, optical storage, network attached storage (NAS), cloud storage, or a storage area-network (SAN) configured to store non-volatile data.

The memory 220 may store instructions and logic for executing an application platform 226. The application platform 226 may include social media content incorporating location based services 222 and proximity accessible media items 224, among other applications. The storage 230 may store social media content and user generated media and may include a database 232 configured to store media associated with a specific geographic location, such as proximity inaccessible media items 234 and application platform content 236. The database 232 may also store application content relating to geographical locations associated with user generated media and other application features for providing the user with a social media application platform that displays media based upon the proximity of a user to a geographical location associated with various media items. The database 232 may be any type of storage device.

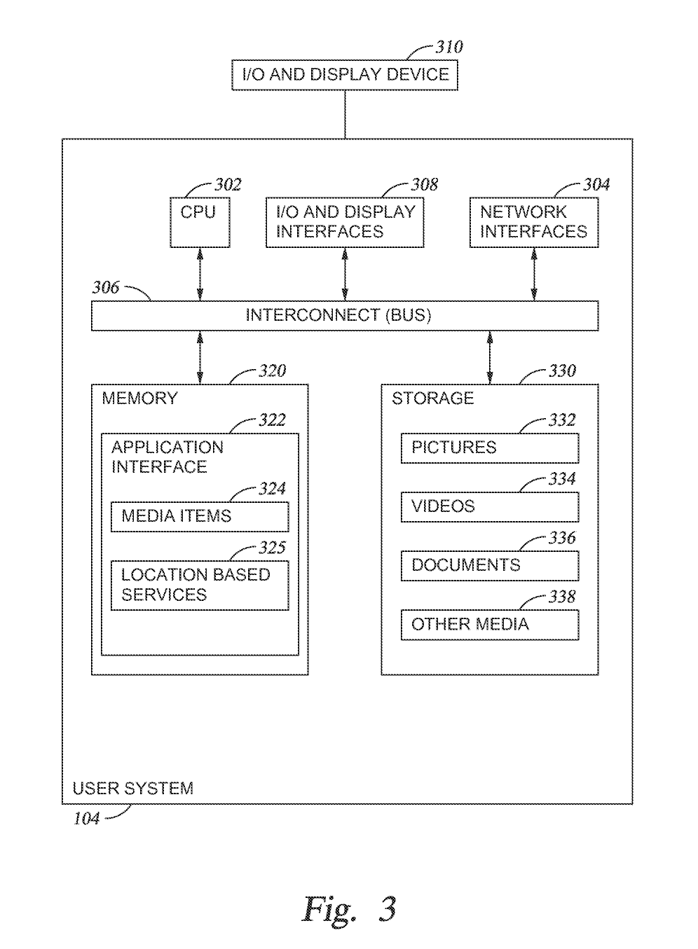

FIG. 3 illustrates a user computing system 104 used to access the location specific experience application server 112 and display media associated with the application platform 226. The user computing system 104 may include, without limitation, a central processing unit (CPU) 302, a network interface 304, an interconnect 306, a memory 320, and storage 330. The computing system 104 may also include an I/O device interface 308 connecting I/O devices 310 (e.g., keyboard, display, touchscreen, and mouse devices) to the computing system 104.

Like CPU 202, CPU 302 is included to be representative of a single CPU, multiple CPU's, a single CPU having multiple processing cores, etc., and the memory 320 is generally included to be representative of a random access memory. The interconnect 306 may be used to transmit programming instructions and application data between the CPU 302, I/O device interfaces 308, storage 330, network interface 304, and memory 320. The network interface 304 may be configured to transmit data via the communications network 102, e.g. to stream content from the location specific experience application server 112. Storage 330, such as a hard disk drive or solid-state storage drive (SSD), may store non-volatile data. The storage 330 may contain pictures 332, videos 334, documents 336, and other media 338 which can be any type of media that may be uploaded to the location specific experience application 106. Illustratively, the memory 320 may include an application interface 322, which itself displays proximity accessible media items 324 with user access determined by user system integrated location based services 325 in communication with the location specific experience application 106. The application interface 322 may provide one or more software applications which allow the user to access media items and other content hosted by the location specific experience application server 112.

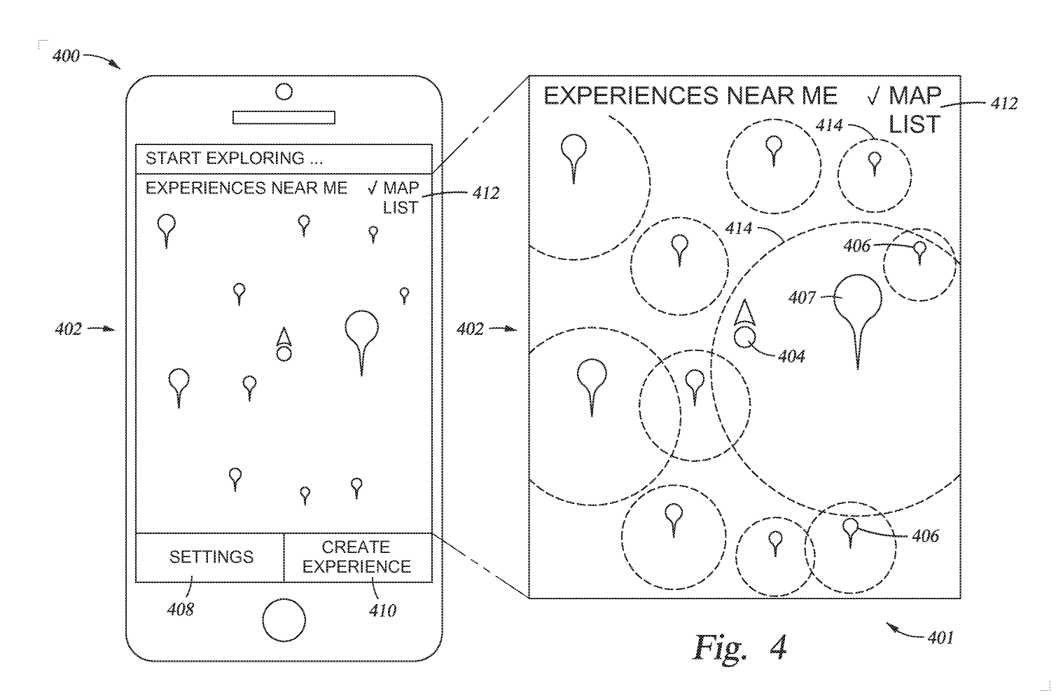

FIG. 4 illustrates the location specific experience application 106 displayed on a GUI 402 of a mobile device 400 and an enlargement 401 of the GUI 402 for illustrative purposes. An interface 412 of the location specific experience application 106 may displayed in various manners. As depicted, the interface 412 is displayed in the GUI 402 as a map having one or more experiences 406. The experiences 406 may also be displayed in a list type format or other type of format such that a user may determine the geographical location of the experiences 406. The experiences 406 may be associated and displayed with a geographical location where the experiences 406 were created. Generally, subject matter of the experiences 406 may relate to the geographical location of the experience 406. For example, an experience which relates to an art museum may be associated with the geographical location of the art museum. However, it is contemplated that the experience's subject matter may not be limited to the geographical location associated with the experiences.

A settings selection 408 will be defined based upon inventor input. The settings selection 408 may provide options which are customized to the user's desire. For example, if a user seeks to access experiences, the settings selection 408 may provide various options related to finding and accessing experiences 406. The settings selection 408 may include various selectable filters to customize the experience desired by the user. For example, if the user wants to experience a restaurant, a filter which designates experiences relating substantially to restaurant experiences may be selected to narrow the types of experiences 406 displayed in the interface 412. Alternatively, if the user seeks to create an experience, the user may select the create experience selection 410 and the options provided to the user in the settings selection 408 may be adapted to help the user create media items and experiences 406.

The experiences 406 may comprise various content, such as media items and the like. The experiences 406 may be displayed with an indicator 407. The indicator 407 may be a pin or other similar indicator displayed on the interface 412. As depicted, the indicator 407 may provide the geographical location of the experience 406 relative to a user's geographical location 404. The user's geographical location 404 and the indicators 407 displayed in the interface 412 are generally determined by location based services integrated in the location specific experience application 106. As such, experiences 406 near the user's geographical location 404 may be displayed to the user to help the user determine which experiences 406 the user would like to access.

Each of the experiences 406 may be associated with an access proximity 414. The access proximity 414 for each experience 406 is specific to each experience 406 and may be determined in relation to the geographical location of the indicator 407 associated with the experience 406. In one embodiment, a first user may create an experience 406 and associate the access proximity 414 in relation to the indicator 407. A second user, whose geographical location 404 is displayed in the interface 412, may seek to access the first user's experience 406. The second user may access the first user's experience if the second user's geographical location is within the access proximity 414 of the first user's experience 406.

The access proximity 414 may encompass a region geographically surrounding the experiences 406 and may be determined by a user that created the experience 406. The access proximity 414 associated with the indicator 407 may display the access proximity 414 as a perimeter or boundary surrounding the indicator 407. The access proximities 414 may have any size or shape as desired by the user that created the experience 406. As illustrated, access proximities 414 of adjacent experiences 406 may overlap with one another or may be separated from one another.

In certain embodiments, the indicators may become interactive based on the user's geographical location 406. For example, indicator 407 may become enlarged, highlighted, or otherwise notify the user when the user is within the proximity 414 of the indicator 407. In one example, the indicator 407 may send push notifications or other information to the user when the user is nearing or within the proximity 414 of the indicator 407. Examples of notifications provided to the user based on the user's proximity to the indicator 407 include advertisements, specials, coupons, promotional materials, pictures, videos, and other information that relates to the type of experience located at the indicator 407.

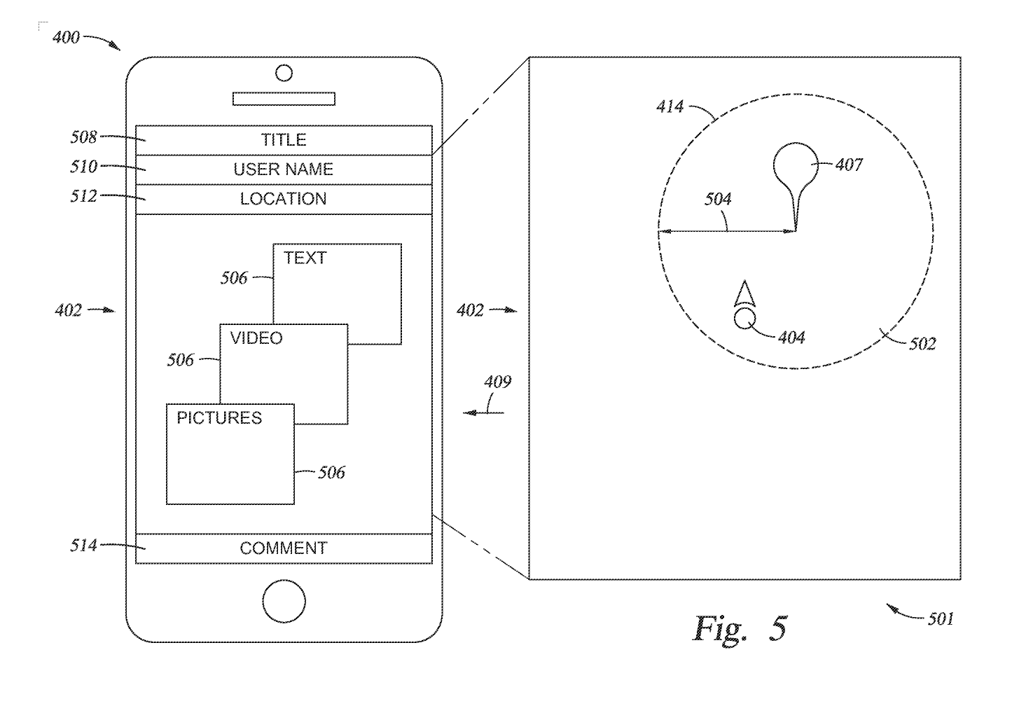

FIG. 5 illustrates an indicator 407 of the location specific experience application displayed on the GUI 402 of FIG. 4 and an enlargement 501 of the GUI 402 according to one embodiment described herein. The enlargement 501 illustrates the user's geographical location 404 relative to the indicator 407 of an experience 406. The access proximity 414 may define an access region 502. The access region 502 may be any area between the access proximity 414 perimeter and the indicator 407. In one example, the access region 502 may be circular and have a radius 504. It is contemplated, however, that the access region 502 may have any desirable shape. As illustrated, the user's geographical location 404 is within the access region 502. To indicate the user's geographical location 404 within the access region 502, the access region 502 may be highlighted or provide some other indication that the user's geographical location 404 is sufficiently close enough to the indicator 407 to allow access to the experience 406. Thus, when the user is within the access region 502, access may be granted to the experience 406. For example, the user may simply provide input, such as touching the indicator 407 on a touchscreen GUI, selecting the experience 406 represented by the indicator 407.

Once access to an experience 406 is granted and the user provides input selecting the indicator 407 associated with the experience 406, a display change 409 occurs and various content of the experience 406 is displayed. The content may include various media items 506, such as pictures, video, and text that create the experience 406. The content may further include information about the experience 406, such as a title 508 of the experience 406, a user name 510 of the user that created the experience 406, and the geographical location 512 of the experience 406. Another option provided to the user accessing the experience 406 includes a comment selection 514. The comment selection 514 may provide the accessing user the ability to comment on the experience or otherwise interact with the user who created the experience 406 or other users accessing the experience.

In one embodiment, the application 106 may determine the geographical locations of two or more users of the application 106. By comparing the geographical locations, the application 106 may determine that multiple users are within a predetermined vicinity of one another, for example, based on the proximity 414 of the indicator, and notify each of the users of the other user's geographical location. Thus, users may be provided with location information of other users participating in the same experience. The notifications regarding the presence of other users may be push notifications or the like.

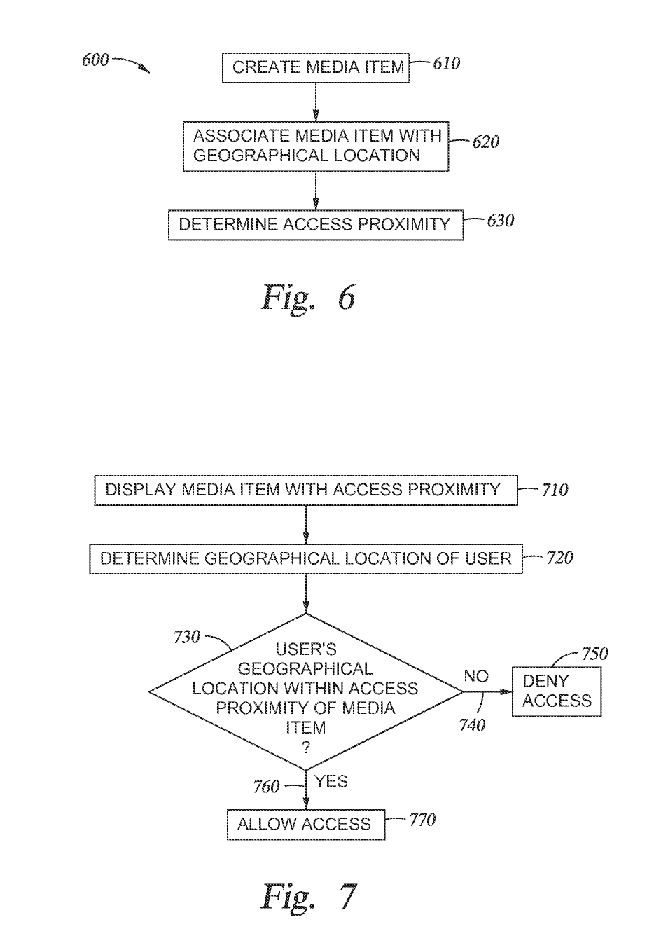

FIG. 6 schematically illustrates operations of a method 600 to generate a media item according to one embodiment described herein. The media item may be associated with a geographical location to create an experience as described in greater detail above. At operation 610, a media item is created. The media item may be generated by a user of the location specific experience application 106 and associated with a geographical location at operation 620. The geographical location associated with the media item is generally the physical location where the media item was created. However, in an alternative embodiment, the media item may be created remotely from the geographical location associated with the media item.

At operation 630, the user that created the media item may determine and associate an access proximity with the media item. The user may also limit access to the media item based on factors other than geographical proximity to the media item. For example, the user may choose to limit access to the media item based on the time of day and the number of other users currently experiencing the media item, among others. Thus, the user that created the media item may customize the experience for other users of the application 106.

FIG. 7 schematically illustrates operations of a method for determining access to a media item provided by the location specific experience application according to one embodiment described herein. The method generally relates to embodiment where a user is attempting to access an experience created by a different user. At operation 710, a media item is displayed with an associated access proximity. At operation 720, the geographical location of a user is determined relative to the access proximity of the media item.

At operation 730 the user's geographical location and the access proximity of the media item are compared to determine if the user's geographical location is within the access proximity of the media item. If the determination made in operation 730 indicates at operation 740 the user's geographical location is not within the access proximity, the user will be denied access to the media item at operation 750. However, if the determination made in operation 730 indicates at operation 760 the user's geographical location is within the access proximity, the user will be allowed access at operation 770.

While the foregoing is directed to embodiments described herein, other and further embodiments may be devised without departing from the basic scope thereof. For example, aspects of the present disclosure may be implemented in hardware or software or in a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the disclosed embodiments, are embodiments of the present disclosure. Therefore, the scope of the embodiments provided herein is determined by the claims that follow.

1. A method of generating and determining access to media content, comprising:
creating a media item associated with a geographical location;
determining an access proximity to the media item;
displaying the media item and the access proximity on a graphical user interface;
determining the geographical location of a user relative to the access proximity; and
determining whether to allow or deny the user access to the media item by comparing the user's geographical location to the access proximity associated with the media item.

2. The method of claim 1, wherein the media item is created by a first user and accessed by a second user when the second user's geographical location is physically within the access proximity.

3. The method of claim 2, wherein the media item is created by the first user and inaccessible by the second user when the second user's geographical location is physically beyond the access proximity.

4. The method of claim 1, wherein the access proximity of the media item is determined by a user that created the media item.

5. The method of claim 1, wherein the media item generates an access indication when the user's geographical location is within the access proximity.

6. The method of claim 1, wherein media item is configured to generate a push notification and notify the user when the user's geographical location is within the access proximity of the media item.

7. The method of claim 1, wherein the graphical user interface displays a map indicating the geographical location of the media item.

8. A non transitory computer-readable storage medium, storing instructions that when executed by a processor, cause the processor to generate and determine access to media content, by performing the steps of:
creating a media item associated with a geographical location;
determining an access proximity to the media item;
displaying the media item and the access proximity on a graphical user interface;
determining the geographical location of a user relative to the access proximity; and
determining whether to allow or deny the user access to the media item by comparing the user's geographical location to the access proximity associated with the media item.

9. The non transitory computer-readable storage medium of claim 8, wherein the media item is created by a first user and accessed by a second user when the second user's geographical location is physically within the access proximity.

10. The non transitory computer-readable storage medium of claim 9, wherein the media item is created by the first user and inaccessible by the second user when the second user's geographical location is physically beyond the access proximity.

11. The non transitory computer-readable storage medium of claim 8, wherein the access proximity of the media item is determined by a user that created the media item.

12. The non transitory computer-readable storage medium of claim 8, wherein the media item generates an access indication when the user's geographical location is within the access proximity.

13. The non transitory computer-readable storage medium of claim 8, wherein media item is configured to generate a push notification and notify the user when the user's geographical location is within the access proximity of the media item.

14. The non transitory computer-readable storage medium of claim 8, wherein the graphical user interface displays a map indicating the geographical location of the media item.

15. A computer system for generating and determining access to media content, comprising:
a processor; and
a memory storing instructions that, when executed by the processor, cause the computer system to:
create a media item associated with a geographical location;
determine an access proximity to the media item;
display the media item and the access proximity on a graphical user interface;
determine the geographical location of a user relative to the access proximity; and
determine whether to allow or deny the user access to the media item by comparing the user's geographical location to the access proximity associated with the media item.

16. The computer system of claim 15, wherein the media item is created by a first user and accessed by a second user when the second user's geographical location is physically within the access proximity.

17. The computer system of claim 16, wherein the media item is created by the first user and inaccessible by the second user when the second user's geographical location is physically beyond the access proximity.

18. The computer system of claim 15, wherein the access proximity of the media item is determined by a user that created the media item.

19. The computer system of claim 15, wherein the media item generates an access indication when the user's geographical location is within the access proximity.

20. The computer system of claim 15, wherein media item is configured to generate a push notification and notify the user when the user's geographical location is within the access proximity of the media item.

21. The computer system of claim 15, wherein the graphical user interface displays a map indicating the geographical location of the media item.
